(19) United States
(12) Patent Application Publication
(10) Pub. No.: US 2005/0144012 A1
(43) Pub. Date: Jun. 30, 2005

(54) One button push to translate languages over a wireless cellular radio

(76) Inventors: Alireza Afrashteh, Reston, VA (US); David Chapman, Reston, VA (US); Mar Tarres, New York, NY (US)

Correspondence Address: MORRISON & FOERSTER LLP, 1650 TYSONS BOULEVARD, SUITE 300, MCLEAN, VA, 22102, US

(21) Appl. No.: 10/980,816

(22) Filed: Nov. 4, 2004

Related U.S. Application Data
(60) Provisional application No. 60/517,383, filed on Nov. 6, 2003.

(51) Int. Cl. G10L 11/00

(52) U.S. Cl. 704/277

(57) ABSTRACT

A system having a plurality of communication devices, at least one of which comprises a control device, a half duplex communication network to transmit data between the plurality of communication devices, and a translation engine to translate voice communications spoken into a first one of the communication devices into at least one other language, wherein when the control device of one of the communication devices is activated, the corresponding communication device secures a floor control of the network, and while the floor control is secured, the communication device communicates with the translation engine such that words spoken into the communication device are translated, and the network transmits the translated communications to selected ones of the plurality of communication devices.

### RELATED APPLICATION

This Application claims the priority of previously filed U.S. Provisional Patent Application No. 60/517,383 filed on Nov. 6, 2003, which is herein incorporated in its entirety by reference.

### FIELD OF THE INVENTION

The invention relates to the field of voice translation over a mobile communications network.

### BACKGROUND OF THE INVENTION

In today's rapidly shrinking world of multinational businesses and a global economy, it is becoming crucial that individuals speaking different languages are able to communicate quickly and accurately. With the increasing mobility of business, it is becoming critical that these communications are able to take place using cellular telephones.

Traditional, full duplex telephone systems have been used to transmit translated messages between two users. However, these full duplex systems are by no means ideal for such a use. A major difficulty with full duplex systems is that both users are able to speak into their phone at the same time. When this occurs, the translation engines can be confused, leading to incorrect translations and even totally intelligible communications.

Examples of the previously used systems include devices that use ordinary telephone lines to transmit translated voice communications. One example of such a system is shown in Van Alstine (U.S. patent application Ser. No. 6,175,819). The previous systems were designed for one-way translation. In other words, only one persons voice could be translated. If a second persons voice needed to be translated, a second system would be used over the same telephone lines. In such systems, as many translation engines are needed as there are users. If five people wanted to translate their voice communications, five translators were necessary. Therefore, in addition to the difficulties in organizing when each speaker should speak, the cost of a multi-user system is very high.

While these problems are significant when two users are present on the system, additional users can quickly render the system effectively inoperable. With no way to control who is talking and when they should talk, the present systems are not capable of effectively handling translation activities when multiple users are connected to the same transmission, for example, in a conference call.

An apparatus and method is needed which allows multiple users speaking different languages to effectively communicate using mobile communications devices that can regulate when each user can transmit information to a translation engine.

### SUMMARY OF THE INVENTION

Various exemplary embodiments of the invention are detailed below. The invention is not limited by the embodiments described.

One embodiment of the invention is a system having a plurality of communication devices, at least one of which comprises a control device, a half duplex communication network to transmit data between the plurality of communication devices, and a translation engine to translate voice communications spoken into a first one of the communication devices into at least one other language.

When the control device of one of the communication devices is activated, the corresponding communication device secures a floor control of the network, and while the floor control is secured, the communication device communicates with the translation engine such that words spoken into the communication device are translated, and the network transmits the translated communications to selected ones of the plurality of communication devices.

In a further embodiment, at least one of the communication devices has a screen to display text and a memory to store information relating to various ones of the plurality of communication devices.

In a further embodiment, the plurality of communication devices are mobile communication devices.

In a further embodiment, the memory stores user profiles of selected ones of the plurality of communication devices, the profiles including a preferred language to which communications are to be translated.

In a further embodiment, the memory stores a preferred language of the communication device housing the memory, such that communications to the communication device are translated into the preferred language.

In a further embodiment, the preferred language associated with each communication device is transmitted to a plurality of communication devices from which it receives data, such that the system automatically translates communications into the preferred language.

In a further embodiment, a user can selectively disable the automatic translation of received communications.

In a further embodiment, the control device is a button that is activated by being depressed.

In a further embodiment, the user can select a voice from a plurality of voices and the selected voice is used to transmit the translated communications.

In a further embodiment, the translation engine first translates the words spoken into the communication device into text which is displayed on the screen and translates the text to voice when the control device is disengaged.

In a further embodiment, if a translation of the displayed text is not desired, the user can speak into the communication device and the original text is overwritten, such that only the displayed text is translated into voice when the user disengages the control device.

In a further embodiment, one of the plurality of communication devices can be designated a monitor device, and the monitor device can assume the floor control at anytime.

In a further embodiment, a translated voice communication can be looped back to an original communication device in a language selected by a user.

An alternate embodiment involves a method of translating voice communications over a half duplex network. The method involves establishing communications between a plurality of communication devices over a half duplex communications network, designating floor control of the network based on a user activating a control device of a communication device such that only the communication device with floor control can transmit data, translating voice data spoken into the communication device having floor control using a translation engine, and transmitting the translated voice data the remaining plurality of communication devices and releasing the floor control when the control device is disengaged.

In a further embodiment, the translating of the voice data comprises translating the voice data into text to be displayed on a display of the communication device that has floor control and translating the text to voice only when the control device is disengaged. In a further embodiment, the displayed text can be overwritten if the user does not wish the displayed text to be translated.

In a further embodiment, at least one of the plurality of communication devices is a mobile communication device.

An alternate embodiment of the invention is system having a plurality of communications devices, a half duplex network configured to enable transmission of information among the plurality of communications devices, a translation engine configured to translate an audible communication from a first language to a second language, and a controller configured to enable at least one of the communications devices to secure floor control of the network. In this embodiment of the invention, an audible communication received by a communications device having floor control of the network is translated by the translation engine from a first language to a second language and the translated audible communication is transmitted via the network to at least one of the plurality of communications devices.

Another embodiment of the invention is a translation apparatus having a communication device having a control device, a half duplex communication network to transmit data to and/or from the communication device, wherein the data comprises voice communications, and a translation engine to translate the voice communications into at least one other language. In this embodiment of the invention, when the control device is activated, the communication device secures a floor control of the network, and while the floor control is secured, the communication device communicates with the translation engine such that words spoken into the communication device are translated, and the network transmits the translated communications.

In a further embodiment, the communication device comprises a screen to display text and a memory to store information relating to various ones of the plurality of communication devices.

In a further embodiment, the communication device is a mobile communication device.

In a further embodiment, the translation engine first translates the words spoken into the communication device into text which is displayed on the screen and translates the text to voice when the control device is disengaged.

In a further embodiment, if a translation of the displayed text is not desired, the user can speak into the communication device and the original text is overwritten, such that only the displayed text is translated into voice when the user disengages the control device

### DESCRIPTION OF THE FIGURES

FIG. 1 depicts an example of a mobile communications device 1.

FIG. 2 depicts an example of a translation according to an embodiment of the invention.

FIG. 3 shows an example of a plurality of mobile devices communicating with a wireless network which transmits data to and from a translation engine.

FIG. 4 shows an example of a voice communication being translated using an embodiment of the invention.

### DETAILED DESCRIPTION

The invention provides a system and method for translating voice data over a half duplex communications network, such that the translation is handled effectively and accurately.

A preferred embodiment of the present invention may have multiple mobile communications devices, such as mobile telephones, that are connected via a half duplex network. A half duplex network is preferable due to the floor control aspect that is inherent in the network. A benefit of floor control is that when one mobile device has floor control, it is the only device that can transmit over the network. When only one mobile device is allowed to send data, it is possible to ensure that the users of each of the devices that receive the transmission receive the entire transmission before they can respond. By locking out transmissions from other mobile devices, the translation engine only receives the voice communications from one user at a time, thereby preventing errors that may otherwise be created by cross talk between the users.

Various translation engines may be utilized in various embodiments of the invention. Such translation engines may include, but are not limited to commercially available translation engines such as the “babelfish” translator available from altavista, the translation engine used by SDL Inc., or other translation engines readily available through the internet.

A further advantage of the floor control is that it gives the user with floor control all the necessary time the user needs to correctly phrase the communications. When communicating with other users who speak a different language, it is important to correctly phrase any statements that are to be communicated. The use of an improper phrase may result in unwanted confusion or offense.

In a further embodiment of the invention, a display may be integrated into each mobile device. When the user with floor control speaks into the mobile device, the voice communications can be translated into a text of the language which is spoken. By translating voice to text in this manner, the user may ensure that what was said is accurately interpreted by the translation engine. This is important because accents or dialects spoken by the user may not always be recognized by the translation engine. If the engine does not correctly interpret the spoken communications, the resulting translation may make no sense to the recipient, or even worse, may be misinterpreted. By displaying the text, the user is able to confirm the message is the one the user wishes to translate. If it is not, the user may repeat the phrase the user wishes to send until it is correct, or the user may choose to use an entirely new statement that is more easily recognized.

When the user is satisfied with the text, the user may indicate that translation is desired, thereby allowing the text to be translated into voice by the translation engine. The translated communications may then be sent to selected mobile devices through the network, and the floor control may be relinquished.

While there are several ways that a user can indicate that floor control is desired, and several ways to release floor control, a preferred embodiment of the invention uses a single button to perform both acts. By using a single button, the preferred embodiment is simple to use and the operation of the device is intuitively obvious to the casual user. In the preferred embodiment, the user may depress the control button to indicate that floor control is desired. When floor control is granted to the user by the network an audible and/or visual signal may be generated to inform the user. Also, audible and/or visual signals may be transmitted to the other mobile devices to indicate that another user currently has floor control. In some embodiments, the signals may indicate which other user has the floor control. In the preferred embodiment, the user maintains floor control until the button is released. Once the button is released, the displayed text is translated by the translation engine and transmitted to the other users.

In a further embodiment of the invention, one of the users may be designated as a moderator. As a moderator, the designated user may be able to commandeer floor control whenever he desires. This may be beneficial because during the course of communications it may be desirable to have the moderator keep the discussion focused, or diffuse any arguments without having to wait until he is able to establish floor control through the ordinary chain of events.

Another aspect of the present invention involves determining what language a spoken communication is to be translated into. According to one embodiment of the invention, each mobile device may have a memory. The memory may be used to store information about other mobile device users. Such information may include, but is not limited to, user name, user contact information, user phone number, user id number, and the user's preferred language. When a first user is communicating with a second user using an embodiment of the invention, the network may identify the preferred language of the second user from the first user's stored profile and translate the spoken communications accordingly.

According to another embodiment of the invention, the memories may store the user's own preferred language. In this embodiment, the network may determine if the first user and the second user have different preferred languages. If they do, the network may translate the spoken communications accordingly. If a third user is present in the same communication, and the third user has a third preferred language, the network may separately translate the spoken communication into the third language for the third user.

In yet another embodiment of the invention, the memory can store several preferred languages for each user, and can inform the users when they share a preferred language such that no translation may be needed. For example, if the first user speaks German and English and designates both languages as preferred languages, and the second user designates both Japanese and English as preferred languages, the network may indicate to both users that they share English as a preferred language and provide the users with the opportunity to communicate without translation.

In a further embodiment of the invention, a user may wish to translate a spoken communication and hear the translated response. This may be desired by a traveler who is trying to communicate with someone who speaks a different language but does not have a communications device. In this case the embodiment may enable the user to “loop back” a communication to the user's own mobile device and select the language of the looped back translation. This could allow an English speaking tourist in Germany to ask direction to his hotel by indicating that he wanted a German translation and then speaking into his mobile device. He could then indicate that he desired a German to English translation and have the German speaker speak into the same device.

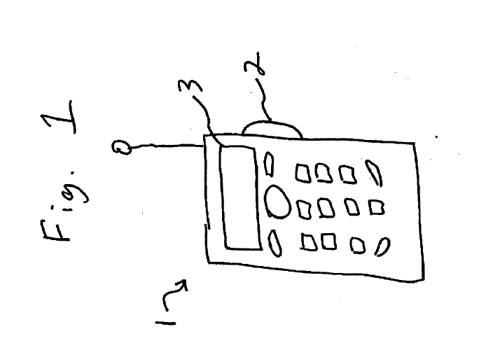

FIG. 1 depicts an example of a mobile communications device 1. The mobile device 1 is shown to have an activation device 2, here shown as a button according to a preferred embodiment of the invention. The mobile device 1 is also shown having a display 3.

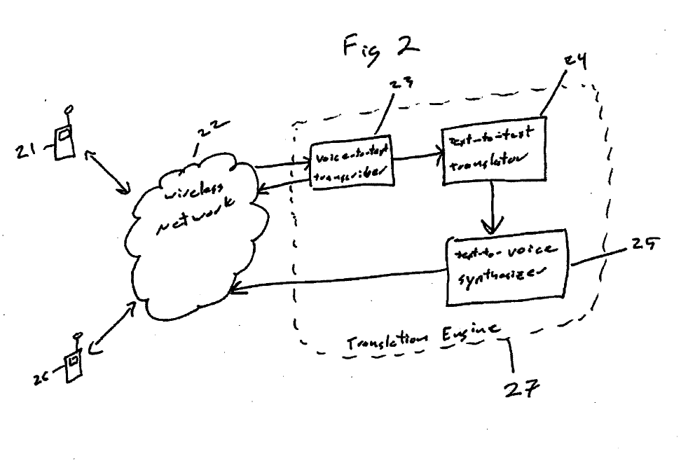

FIG. 2 depicts an example of a translation according to an embodiment of the invention. FIG. 2 shows a communication between a first mobile device 21 and a second mobile device 26. As shown in FIG. 2, a first user speaks into the first mobile device 21, the voice communication is then transmitted to the wireless network 22. The wireless network then transmits the voice communication to the voice-to-text transcriber 23. The voice-to-text transcriber 23 then transcribes the voice communication into text using the same language. The transcribed text is then transmitted to the wireless network 22 which then transmits it to the first mobile device 21, where it is displayed for the first user. When the first user approves of the text, a signal is sent to the wireless network 22 and then to the voice-to-text transcriber 23 which sends the transcribed text to a text-to-text translator 24 which translates the text into text of the desired language. The translated text is then sent to a text-to-voice synthesizer 25 which synthesizes the desired text. In a preferred embodiment, the first user can choose a desired sound for the synthesized voice. The first user may choose characteristics such as age, sex, tone, and pitch, or may choose from a plurality of standard voices. The synthesized voice is then transmitted to the wireless network 22, and finally to the second mobile device 26. As shown in FIG. 2, the voice-to-text transcriber 23, the text-to-text translator 24, and the text-to-voice synthesizer 25 are part of a translator engine 27.

While an embodiment of a translation engine is shown in FIG. 2, the exact composition of the translation engine is not critical to the invention.

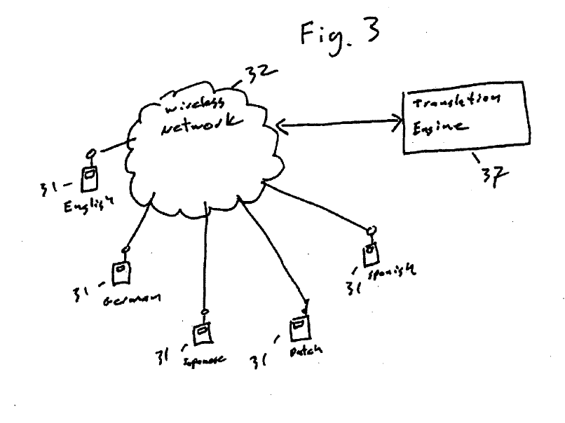

FIG. 3 shows an example of a plurality of mobile devices 31 communicating with a wireless network 32 which transmits data to and from a translation engine 37. As shown in FIG. 3, a plurality of mobile devices 31 each having a different preferred language can communicate through the same wireless network 32 which uses a translation engine 37 such that the mobile devices 31 receive voice transmissions in their preferred language.

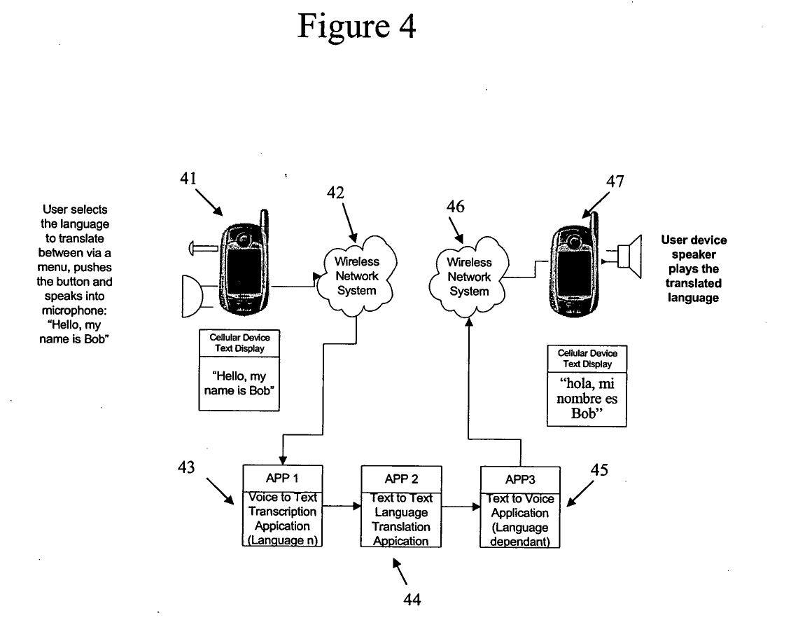

FIG. 4 shows an example of a voice communication being translated using an embodiment of the invention. In FIG. 4, a user speaks the words “Hello, my name is Bob” into a first mobile communication device 41. The voice communication is transmitted to a first wireless network system 42. The first wireless network system 42 then transmits the voice communication to a voice to text transcription application 43 where the voice communication is transcribed in the original language. The transcribed text is the transmitted to a text to text language translation application 44, where the text is translated to another language, in this example Spanish. The translated text is then transmitted to a text to voice application 45, where the Spanish language text is translated into a voice signal. In this example the text is translated to “Hola, mi nombre es Bob.” The translated voice signal is then transmitted to a second wireless network 46, which transmits the signal to a second mobile communications device 47 where it my be heard by a user.

In an alternate embodiment, the first wireless network 42 and the second wireless network 46 may be the same wireless network.

1. A system comprising:
a plurality of communication devices, at least one of which comprises a control device,
a half duplex communication network to transmit data between the plurality of communication devices, and
a translation engine to translate voice communications spoken into a first one of the communication devices into at least one other language,
wherein when the control device of one of the communication devices is activated, the corresponding communication device secures a floor control of the network, and while the floor control is secured, the communication device communicates with the translation engine such that words spoken into the communication device are translated, and the network transmits the translated communications to selected ones of the plurality of communication devices.

2. The system of claim 1, wherein at least one of the communication devices comprises:
a screen to display text and a memory to store information relating to various ones of the plurality of communication devices.

3. The system of claim 2, wherein the plurality of communication devices are mobile communication devices.

4. The system of claim 2, wherein the memory stores user profiles of selected ones of the plurality of communication devices, the profiles including a preferred language to which communications are to be translated.

5. The system of claim 2, wherein the memory stores a preferred language of the communication device housing the memory, such that communications to the communication device are translated into the preferred language.

6. The system of claim 5, wherein the preferred language associated with each communication device is transmitted to a plurality of communication devices from which it receives data, such that the system automatically translates communications into the preferred language.

7. The system of claim 6, wherein a user can selectively disable the automatic translation of received communications.

8. The system of claim 1, wherein the control device is a button that is activated by being depressed.

9. The system of claim 1, wherein the user can select a voice from a plurality of voices and the selected voice is used to transmit the translated communications.

10. The system of claim 2, wherein the translation engine first translates the words spoken into the communication device into text which is displayed on the screen and translates the text to voice when the control device is disengaged.

11. The system of claim 10, wherein, if a translation of the displayed text is not desired, the user can speak into the communication device and the original text is overwritten, such that only the displayed text is translated into voice when the user disengages the control device.

12. The system of claim 1, wherein one of the plurality of communication devices can be designated a monitor device, and the monitor device can assume the floor control at anytime.

13. The system of claim 1, wherein a translated voice communication can be looped back to an original communication device in a language selected by a user.

14. A method of translating voice communications over a half duplex network, the method comprising:
establishing communications between a plurality of communication devices over a half duplex communications network,
designating floor control of the network based on a user activating a control device of a communication device such that only the communication device with floor control can transmit data,
translating voice data spoken into the communication device having floor control using a translation engine,
transmitting the translated voice data the remaining plurality of communication devices and releasing the floor control when the control device is disengaged.

15. The method of claim 14, wherein the translating of the voice data comprises translating the voice data into text to be displayed on a display of the communication device that has floor control and translating the text to voice only when the control device is disengaged.

16. The method of claim 15, wherein the displayed text can be overwritten if the user does not wish the displayed text to be translated.

17. The method of claim 15, wherein at least one of the plurality of communication devices is a mobile communication device.

18. A system comprising:
a plurality of communications devices,
a half duplex network configured to enable transmission of information among the plurality of communications devices,
a translation engine configured to translate an audible communication from a first language to a second language, and
a controller configured to enable at least one of the communications devices to secure floor control of the network,
whereby an audible communication received by a communications device having floor control of the network is translated by the translation engine from a first language to a second language and the translated audible communication is transmitted via the network to at least one of the plurality of communications devices.

19. A translation apparatus comprising:
a communication device having a control device,
a half duplex communication network to transmit data to and/or from the communication device, wherein the data comprises voice communications, and
a translation engine to translate the voice communications into at least one other language,
wherein when the control device is activated, the communication device secures a floor control of the network, and while the floor control is secured, the communication device communicates with the translation engine such that words spoken into the communication device are translated, and the network transmits the translated communications.

20. The apparatus of claim 1, wherein the communication device comprises a screen to display text and a memory to store information relating to various ones of the plurality of communication devices.

21. The system of claim 20, wherein the communication device is a mobile communication device.

22. The system of claim 20, wherein the translation engine first translates the words spoken into the communication device into text which is displayed on the screen and translates the text to voice when the control device is disengaged.

23. The system of claim 22, wherein, if a translation of the displayed text is not desired, the user can speak into the communication device and the original text is overwritten, such that only the displayed text is translated into voice when the user disengages the control device.
